(19) United States
(12) Patent Application Publication
(10) Pub. No.: US 2015/0301510 A1
(43) Pub. Date: Oct. 22, 2015

(54) Controlling a Target System

(71) Applicants: Siegmund Düll, Munchen (DE); Mrinal Munshi, Orlando, FL (US); Sigurd Spieckermann, Buxtehude (DE); Steffen Udluft, Eichenau (DE)

(72) Inventors: Siegmund Düll, Munchen (DE); Mrinal Munshi, Orlando, FL (US); Sigurd Spieckermann, Buxtehude (DE); Steffen Udluft, Eichenau (DE)

(21) Appl. No.: 14/258,740

(22) Filed: Apr. 22, 2014

(51) Int. Cl. G05B 15/02; G06N 3/08

(52) U.S. Cl. CPC G05B 15/02; G06N 3/08

(57) ABSTRACT

For controlling a target system, operational data of a plurality of source systems are used. The data of the source systems are received and are distinguished by source system specific identifiers. By a neural network, a neural model is trained on the basis of the received operational data of the source systems taking into account the source system specific identifiers, where a first neural model component is trained on properties shared by the source systems and a second neural model component is trained on properties varying between the source systems. After receiving operational data of the target system, the trained neural model is further trained on the basis of the operational data of the target system, where a further training of the second neural model component is given preference over a further training of the first neural model component. The target system is controlled by the further trained neural network.

### BACKGROUND

The control of complex dynamical technical systems, (e.g., gas turbines, wind turbines, or other plants), may be optimized by so-called data driven approaches. With that, various aspects of such dynamical systems may be improved. For example, efficiency, combustion dynamics, or emissions for gas turbines may be improved. Additionally, life-time consumption, efficiency, or yaw for wind turbines may be improved.

Modern data driven optimization utilizes machine learning methods for improving control strategies or policies of dynamical systems with regard to general or specific optimization goals. Such machine learning methods may allow to outperform conventional control strategies. In particular, if the controlled system is changing, an adaptive control approach capable of learning and adjusting a control strategy according to the new situation and new properties of the dynamical system may be advantageous over conventional non-learning control strategies.

However, in order to optimize complex dynamical systems, (e.g., gas turbines or other plants), a sufficient amount of operational data is to be collected in order to find or learn a good control strategy. Thus, in case of commissioning a new plant, upgrading or modifying it, it may take some time to collect sufficient operational data of the new or changed system before a good control strategy is available. Reasons for such changes might be wear, changed parts after a repair, or different environmental conditions.

Known methods for machine learning include reinforcement learning methods that focus on data efficient learning for a specified dynamical system. However, even when using these methods, it may take some time until a good data driven control strategy is available after a change of the dynamical system. Until then, the changed dynamical system operates outside a possibly optimized envelope. If the change rate of the dynamical system is very high, only sub-optimal results for a data driven optimization may be achieved since a sufficient amount of operational data may be never available.

### SUMMARY

The scope of the present invention is defined solely by the appended claims and is not affected to any degree by the statements within this summary. The present embodiments may obviate one or more of the drawbacks or limitations in the related art.

In view of the above, an object of the embodiments is to create a method, a controller, and a computer program product with instructions for processor implementation stored on a non-transitory medium for controlling a target system that allow a more rapid learning of control strategies, in particular, for a changing target system.

A method, a controller, or a computer program product stored on a non-transitory medium for controlling a target system, (e.g., a gas or wind turbine or another technical system), is based on operational data of a plurality of source systems. The method, controller, or computer program product stored on a non-transitory medium is configured to receive the operational data of the source systems, the operational data being distinguished by source system specific identifiers. By a neural network, a neural model is trained on the basis of the received operational data of the source systems taking into account the source system specific identifiers, where a first neural model component is trained on properties shared by the source systems and a second neural model component is trained on properties varying between the source systems. After receiving operational data of the target system, the trained neural model is further trained on the basis of the operational data of the target system, where a further training of the second neural model component is given preference over a further training of the first neural model component. The target system is controlled by the further trained neural network.

Because the embodiments use operational data of a plurality of source systems and uses neural models learned by these operational data, one has a good starting point for a neural model of the target system. Actually, much less operational data from the target system are needed in order to obtain an accurate neural model for the target system than in the case of learning a neural model for the target system from scratch. Hence, effective control strategies or policies may be learned in a short time even for target systems with scarce data.

In one embodiment, the first neural model component may be represented by first adaptive weights, and the second neural model component may be represented by second adaptive weights. Such adaptive weights may also be denoted as parameters of the respective neural model component.

The number of the second adaptive weights may be several times smaller than the number of the first adaptive weights. Because the training of the second neural model component represented by the second adaptive weights is given preference over the training of the first neural model component represented by the first adaptive weights, the number of weights to be adapted during the further training with the target system may be significantly reduced. This allows a more rapid learning for the target system.

Furthermore, the first adaptive weights may include a first weight matrix and the second adaptive weights may include a second weight matrix. The second weight matrix may be a diagonal matrix. For determining adaptive weights of the neural model, the first weight matrix may be multiplied by the second weight matrix.

According to an embodiment, the first neural model component may be not further trained. This allows focusing on the training of the second neural model component reflecting the properties varying between the source systems.

Alternatively, when further training the trained neural model, a first subset of the first adaptive weights may be substantially kept constant while a second subset of the first adaptive weights may be further trained. This allows a fine tuning of the first neural network component reflecting the properties shared by the systems even during the further training phase.

According to an embodiment, the neural model may be a reinforcement learning model, which allows an efficient learning of control strategies for dynamical systems.

Advantageously, the neural network may operate as a recurrent neural network. This allows for maintaining an internal state enabling an efficient detection of time dependent patterns when controlling a dynamical system. Moreover, many so-called Partially Observable Markov Decision Processes may be handled like so-called Markov Decision Processes by a recurrent neural network.

According to an embodiment, it may be determined, during training of the neural model, whether the neural model reflects a distinction between the properties shared by the source systems and the properties varying between the source systems. In dependence of that determination, the training of the neural model may be affected. In particular, the training of the neural model on the basis of the operational data of the source systems may be finished if such a distinction is detected with a predetermined reliability.

Moreover, policies or control strategies resulting from the trained neural model may be run in a closed learning loop with the technical target system.

### BRIEF DESCRIPTION OF THE DRAWINGS

FIG. 1 depicts an architecture of a recurrent neural network in accordance with an exemplary embodiment.

FIG. 2 depicts an exemplary embodiment including a target system, a plurality of source systems, and a controller.

### DETAILED DESCRIPTION

According to the embodiments, a target system is controlled not only by operational data of that target system but also by operational data of a plurality of source systems. The target system and the source systems may be gas or wind turbines or other dynamical systems including simulation tools for simulating a dynamical system.

The source systems are chosen to be similar to the target system. In that case, the operational data of the source systems and a neural model trained by the source systems are a good starting point for a neural model of the target system. With the usage of operational data or other information from other, similar technical systems the amount of operational data required for learning an efficient control strategy or policy for the target system may be reduced considerably. The approach increases the overall data efficiency of the learning system and significantly reduces the amount of data required before a first data driven control strategy may be derived for a newly commissioned target system.

According to an embodiment, a gas turbine may be controlled as a target system by a neural network pre-trained with operational data from a plurality of similar gas turbines as source systems. The source systems may include the target system at a different time, e.g., before maintenance of the target system or before exchange of a system component, etc. Vice versa, the target system may be one of the source systems at a later time. The neural network may be implemented as a recurrent neural network.

Instead of training a distinct neural model for each of the source systems separately, a joint neural model for the family of similar source systems is trained based on operational data of all systems. That neural model includes as a first neural model component a global module that allows operational knowledge to be shared across all source systems. Moreover, the neural model includes as a second neural model component source-system-specific modules that enable the neural model to fine-tune for each source system individually. In this way, it is possible to learn better neural models, and therefore, control strategies or policies even for systems with scarce data, in particular, for a target system similar to the source systems.

Let I_{source} and I_{target} denote two sets of system-specific identifiers of similar dynamical systems. The identifiers from the set I_{source} each identify one of the source systems while the identifiers from the set I_{target} identify the target system. It is assumed that the source systems have been observed sufficiently long such that there is enough operational data available to learn an accurate neural model of the source systems while, in contrast, there is only a small amount of operational data of the target system available. Since the systems have similar dynamical properties, transferring knowledge from the well-observed source systems to the scarcely observed target system is an advantageous approach to improve the model quality of the latter.

Let s₁εS denote an initial state of the dynamical systems considered where S denotes a state space of the dynamical systems, and let a₁, . . . , aᵣ denote a T-step sequence of actions with aₜεA being an action in an action space A of the dynamical systems at a time step r. Furthermore, let h₁, . . . , h_{T+1} denote a hidden state sequence of the recurrent neural network. Then a recurrent neural network model of a single dynamical system, which yields a successor state sequence ŝ₂, . . . , ŝ_{T+1}, may be defined by the following equations:

h₁=σₙ(Wₕₛs₁+b₁)

hₜ₊₁=σₕ(Wₕₐaₜ+Wₕₕhₜ+bₕ)

ŝₜ₊₁=Wₛₕhₜ₊₁+bₛ

where Wᵥᵤε [symbol] is a weight matrix from layer to layer v, the latter being layers of the recurrent neural network. bᵥε [symbol] is a bias vector of layer v, nᵥ is the size of layer v and σ(·) is an element-wise nonlinear function, e.g., tan h(·). Wᵤᵥ and bᵥ may be regarded as adaptive weights that are adapted during the learning process of the recurrent neural network.

In order to enable knowledge transfer from the source systems to the target system, the state transition Wₕₕhₜ, which describes the temporal evolution of the states ignoring external forces, and the effect of an external force Wₕₐaₜ, may be modified in order to share knowledge common to all source systems, while yet being able to distinguish between the peculiarities of each source system. Therefore, the weight matrix Wₕₕ is factored yielding:

Wₕₕ≈W_{hf}_{ₕ}diag(W_{f}_{ₕ}_{z}z)W_{f}_{ₕ}ₕ

where zε{e₁, . . . , e_{|I}_{_{source}}_{∪I}_{_{target|}}} is an Euclidean basis vector having a “1” at the position iεI_{source} ∪I_{target} and “0”s elsewhere. For example, the vector z carries the information by which the recurrent neural network may distinguish the specific source systems. In consequence, z acts as a column selector of W_{f}_{ⱼ}_{z} such that there is a distinct set of parameters W_{f}_{ₕ}_{z}Z allocated for each source system. The transformation is therefore a composition of the adaptive weights Wₕ_{_{fh}} and W_{f}_{ₕ}ₕ, which are shared among all source systems, and the adaptive weights W_{f}_{ₕ}_{z} specific to each source system.

The same factorization technique is applied to Wₕₐ yielding:

Wₕₐ≈W_{hf}_{ₐ} diag(W_{f}_{ₐ}_{z}Z)W_{f}_{ₐ}ₐ.

The resulting factored tensor recurrent neural network is then described by the following equations:

h₁=σₕ(Wₕₐs₁+b₁)

hₜ₊₁=σₕ(W_{hf}_{ₐ} diag(W_{f}_{ₐ}_{z}Z)W_{f}_{ₐ}ₐaₜ+W_{hf}_{ₕ} diag(W_{f}_{ₕ}_{z}Z)W_{f}_{ₕ}ₕhₜ+bₕ)

Thus, the adaptive weights W_{hf}_{ₕ}, W_{f}_{ₕ}ₕ, W_{hfa}, W_{faa}, bₕ, Wₛₕ, and bₛ refer to properties shared by all source systems and the adaptive weights of the diagonal matrices diag(W_{fhz}z) and diag(W_{faz} z) refer to properties varying between the source systems. For example, the adaptive weights W_{hf}_{ₕ}, W_{f}_{ₕ}ₕ, W_{hfa}, W_{faa}, bₕ, Wₛₕ, and bₛ represent the first neural model component, while the adaptive weights diag(W_{fhz} z) and diag(W_{faz} z) represent the second neural model component. As diag(W_{fhz} z) and diag(W_{faz} z) are diagonal matrices, these adaptive weights include fewer parameters than the first adaptive weights. For example, the training of the second neural model component requires less time and/or less operational data than the training of the first neural model component.

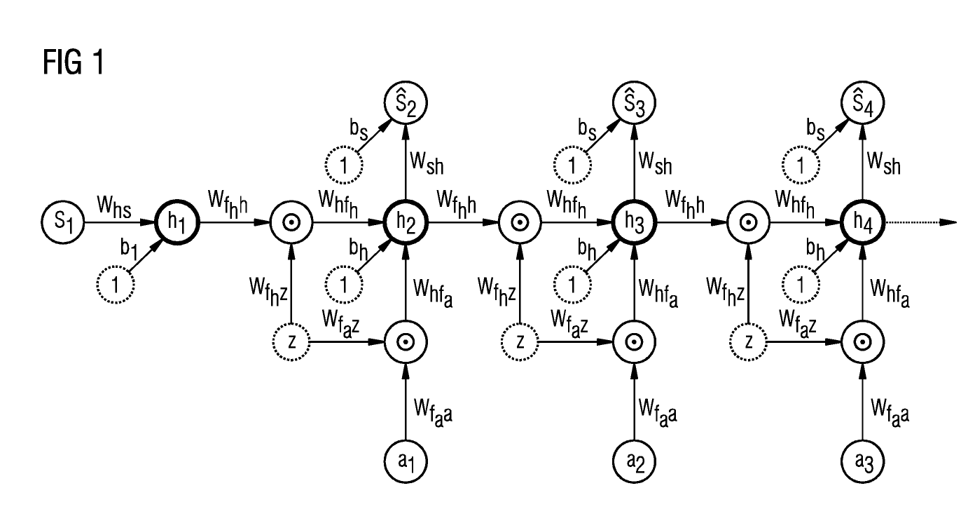

FIG. 1 depicts a graphical representation of the factored tensor recurrent neural network architecture described above. The dotted nodes in FIG. 1 indicate identical nodes that are replicated for convenience. The nodes having the ⊙-symbol in their centers are “multiplication nodes”, e.g., the input vectors of the nodes are multiplied component-wise. The standard nodes, in contrast, imply the summation of all input vectors. Bold bordered nodes indicate the use of an activation function, e.g., “tan h”(·).

Apart from the above described factorizations of the weight matrices additional or alternative representations may be used. For example, the weight matrices W_{hf}_{ₕ}, W_{f}_{ₕ}ₕ, W_{hfa}, and/or W_{faa} may be restricted to symmetric form. In certain embodiments, a system specific matrix diag(W z) may be added to the weight matrix Wₕₕ shared by the source systems. Wₕₕ may be restricted to a low rank representation: Wₕₕ≈Wₕᵤ Wᵤₕ. Moreover, Wᵤₕ may be restricted to symmetric form. In other embodiments, the bias vector bₕ may be made system specific, e.g., depend on z. In yet other embodiments, when merging information of multiple source or target systems into a neural model, issues may occur due to miscalibrated sensors from which the operational data are derived or by which the actions are controlled. In order to cope with artifacts resulting from miscalibrated sensors, the weight matrix Wₛₕ and/or the bias vector bₛ may be made system specific, e.g., depend on the vector z. In particular, these weight matrices may include a z-dependent diagonal matrix.

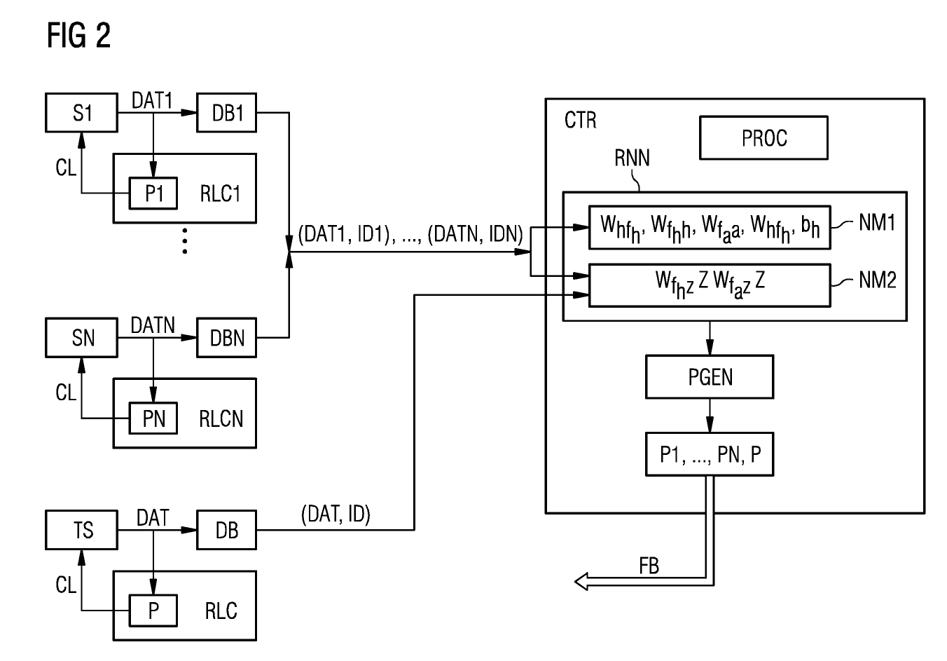

FIG. 2 depicts a sketch of an exemplary embodiment including a target system TS, a plurality of source systems S1, . . . , SN, and a controller CTR. The target system TS may be, e.g., a gas turbine, and the source systems S1, . . . , SN may be, e.g., gas turbines similar to the target system TS.

Each of the source systems S1, . . . , SN is controlled by a reinforcement learning controller RLC1, RLC2, . . . , or RLCN, respectively, the latter being driven by a control strategy or policy P1, P2, . . . , or PN, respectively. Source system specific operational data DAT1, . . . , DATN of the source systems S1, . . . , SN are stored in data bases DB1, . . . , DBN. The operational data DAT1, . . . , DATN are distinguished by source system specific identifiers ID1, . . . , IDN from I_{source}. Moreover, the respective operational data DAT1, DAT2, . . . , or DATN, are processed according to the respective policy P1, P2, . . . , or PN in the respective reinforcement learning controller RLC1, RLC2, . . . , or RLCN. The control output of the respective policy P1, P2, . . . , or PN is fed back into the respective source system S1, . . . , or SN via a control loop CL, resulting in a closed learning loop for the respective reinforcement learning controller RLC1, RLC2, . . . , or RLCN.

Accordingly, the target system TS is controlled by a reinforcement learning controller RLC driven by a control strategy or policy P. Operational data DAT specific to the target system TS are stored in a data base DB. The operational data DAT are distinguished from the operational data DAT1, . . . , DATN of the source systems S1, . . . , SN by a target system specific identifier ID from I_{target}. Moreover, the operational data DAT are processed according to the policy P in the reinforcement learning controller RLC. The control output of the policy P is fed back into the target system TS via a control loop CL, resulting in a closed learning loop for the reinforcement learning controller RLC.

The controller CTR includes a processor PROC, a recurrent neural network RNN, and a reinforcement learning policy generator PGEN. The recurrent neural network RNN implements a neural model including a first neural model component NM1 to be trained on properties shared by all source systems S1, . . . , SN and a second neural model component NM2 to be trained on properties varying between the source systems S1, . . . , SN, e.g., on source system specific properties.

As already mentioned above, the first neural model component NM1 is represented by the adaptive weights W_{hf}_{ₕ}, W_{f}_{ₕ}ₕ, W_{hfa}, W_{faa}, bₕ, Wₛₕ, and bₛ while the second neural model component NM2 is represented by the adaptive weights diag(W_{fhz} z) and diag(W_{faz} z).

By the recurrent neural network RNN, the reinforcement learning policy generator PGEN generates the policies or control strategies P1, . . . , PN, and P. A respective generated policy P1, . . . , PN, P is then fed back to a respective reinforcement learning controller RLC1, . . . , RLCN, or RLC, as indicated by a bold arrow FB in FIG. 2. With that, a learning loop is closed and the generated policies P1, . . . , PN and/or P are running in closed loop with the dynamical systems S1, . . . , SN and/or TS.

The training of the recurrent neural network RNN includes two phases. In a first phase, a joint neural model is trained on the operational data DAT1, . . . , DATN of the source systems S1, . . . , SN. For this purpose, the operational data DAT1, . . . , DATN are transmitted together with the source system specific identifiers ID1, . . . , IDN from the databases DB1, . . . , DBN to the controller CTR. In this first training phase, the first neural model component NM1 is trained on properties shared by all source systems S1, . . . , SN and the second neural model component NM2 is trained on properties varying between the source systems S1, . . . , SN. Here, the source systems S1, . . . , SN and their operational data DAT1, . . . , DATN are distinguished by the system-specific identifiers ID1, . . . , IDN from represented by the vector z.

In a second phase, the recurrent neural network RNN is further trained by the operational data DAT of the target system TS. Here, the shared parameters W_{hf}_{ₕ}, W_{f}_{ₕ}ₕ, W_{hfa}, W_{faa}, bₕ, Wₛₕ, and bₛ representing the first neural model component NM1 and adapted in the first phase are reused and remain fixed while the system specific parameters diag(W_{fhz} z) and diag(W_{faz} z) representing the second neural model component NM2 are further trained by the operational data DAT of the target system TS. The recurrent neural network RNN distinguishes the operational data DAT of the target system TS from the operational data DAT1, . . . , DATN of the source systems S1, . . . , SN by the target system specific identifier ID.

Due to the fact that the general structure of the dynamics of the family of similar source systems S1, . . . , SN is learned in the first training phase, adapting the system specific parameters of a possibly unseen target system TS may be completed within seconds despite a high complexity of the overall model. At the same time, only little operational data DAT are required to achieve a low model error on the target system TS. In addition, the neural model of the target system TS is more robust to overfitting, which appears as a common problem when only small amounts of operational data DAT are available, compared to a model that does not exploit prior knowledge of the source systems S1, . . . , SN. With the embodiments, the peculiarities in which the target system TS differs from the source systems S1, . . . , SN remain to be determined.

There are a number of ways to design the training procedures in order to obtain knowledge transfer from source systems S1, . . . , SN to the target system TS including but not limited to the following variants. Given a joint neural model that was trained on operational data DAT1, . . . , DATN from a sufficient number of source systems S1, . . . , SN, and given a new target system TS that is similar to the source systems S1, . . . , SN on which the joint neural model was trained, it becomes very data-efficient to obtain an accurate neural model for the similar target system TS. In this case, the shared parameters, W_{hf}_{ₕ}, W_{f}_{ₕ}ₕ, W_{hfa}, W_{faa}, bₕ, Wₛₕ, and bₛ of the joint neural model may be frozen and only the systems specific parameters diag(W_{fhz} z) and diag(W_{faz} z) are further trained on the operational data DAT of the new target system TS. Since the number of system specific parameters is typically very small, only very little operational data is required for the second training phase. The underlying idea is that the operational data DAT1, . . . , DATN of a sufficient number of source systems S1, . . . , SN used for training the joint neural model contain enough information for the joint neural model to distinguish between the general dynamics of the family of source systems S1, . . . , SN and the source system specific characteristics. The general dynamics are encoded into the shared parameters W_{hf}_{ₕ}, W_{f}_{ₕ}ₕ, W_{hfa}, W_{faa}, bₕ, Wₛₕ, and bₛ allowing efficient transfer of the knowledge to the new similar target system TS for which only the few characteristic aspects need to be learned in the second training phase.

For a new target system TS that is not sufficiently similar to the source systems S1, . . . , SN on which the joint model was trained, the general dynamics learned by the joint neural model may differ too much from the dynamics of the new target system TS in order to transfer the knowledge to the new target system TS without further adaption of the shared parameters. This may also be the case if the number of source systems S1, . . . , SN used to train the joint neural model is too small in order to extract sufficient knowledge of the general dynamics of the overall family of systems.

In both cases, it may be advantageous to adapt the shared adaptive weights W_{hf}_{ₕ}, W_{f}_{ₕ}ₕ, W_{hfa}, W_{faa}, bₕ, Wₛₕ, and bₛ also during the second training phase. In this case, the operational data DAT1, . . . , DATN used for training the joint neural model are extended by the operational data DAT from the new target system TS and all adaptive weights remain free for adaptation also during the second training phase. The adaptive weights trained in the first training phase of the joint neural model are used to initialize a neural model of the target system TS, that neural model being an extension of the joint neural model containing an additional set of adaptive weights specific to the new target system TS. Thus, the time required for the second training phase may be significantly reduced because most of the parameters are already initialized to good values in the parameter space and minimal further training is necessary for the extended joint neural model to reach convergence.

Variations of that approach include freezing a subset of the adaptive weights and using subsets of the operational data DAT1, . . . , DATN, DAT for further training. Instead of initializing the extended joint neural model with the adaptive weights of the initial joint neural model, those adaptive weights may be initialized randomly, and the extended neural model may be further trained from scratch with data from all systems S1, . . . , SN, and TS.

The embodiments allow to leverage information or knowledge from a family of source systems S1, . . . , SN with respect to system dynamics enabling data-efficient training of a recurrent neural network simulation for a whole set of systems of similar or same type. This approach facilitates a jump-start when deploying a learning neural network to a specific new target system TS, e.g., the approach achieves a significantly better optimization performance with little operational data DAT of the new target system TS compared to a learning model without such a knowledge transfer.

Further advantages of such information sharing between learning models for similar systems include a better adjustability to environmental conditions, e.g., if the different systems are located within different climes. The learning model may also generalize towards different kinds of degradation, providing improved optimization capabilities for rare or uncommon situations because the combined information, gathered from all systems may be utilized.

The instructions for implementing processes or methods of the learning model may be provided on non-transitory computer-readable storage media or memories, such as a cache, buffer, RAM, FLASH, removable media, hard drive, or other computer readable storage media. A processor performs or executes the instructions to train and/or apply a trained model for controlling a system. Computer readable storage media include various types of volatile and non-volatile storage media. The functions, acts, or tasks illustrated in the figures or described herein may be executed in response to one or more sets of instructions stored in or on computer readable storage media. The functions, acts or tasks may be independent of the particular type of instruction set, storage media, processor or processing strategy and may be performed by software, hardware, integrated circuits, firmware, micro code and the like, operating alone or in combination. Likewise, processing strategies may include multiprocessing, multitasking, parallel processing and the like.

The term “computer-readable storage media” includes a single medium or multiple media, such as a centralized or distributed database, and/or associated caches and servers that store one or more sets of instructions. The term “computer-readable storage media” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable storage media may include a solid-state memory such as a memory card or other package that houses one or more non-volatile read-only memories. Further, the computer-readable storage media may be a random access memory or other volatile re-writable memory. Additionally, the computer-readable storage media may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable storage media or a distribution medium and other equivalents and successor media, in which data or instructions may be stored.

A computer program (also known as a program, software, software application, script, or code) may be written in any form of programming language, including compiled or interpreted languages, and it may be deployed in any form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes, training, and/or logic flows described in this specification may be performed by one or more programmable processors executing one or more computer programs to perform functions by operating on input data and generating output. Processors suitable for the execution of a computer program include, by way of example, both general and special purpose microprocessors, and anyone or more processors of any kind of digital computer. Generally, a processor receives instructions and data from a read only memory or a random access memory or both. The essential elements of a computer are a processor for performing instructions and one or more memory devices for storing instructions and data. Generally, a computer also includes, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., E PROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present invention has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A method for controlling a target system on the basis of operational data of a plurality of source systems, the method comprising:
a) receiving, using a processor, operational data of the plurality of source systems, the operational data being distinguished by source system specific identifiers;
b) training, by a neural network run by the processor, a neural model on the basis of the received operational data of the plurality of source systems and the source system specific identifiers, wherein a first neural model component is trained on properties shared by the plurality of source systems and a second neural model component is trained on properties varying between the plurality of source systems;
c) receiving operational data of the target system;
d) further training the trained neural model on the basis of the operational data of the target system to provide a further trained neural network, wherein a further training of the second neural model component is provided preference over a further training of the first neural model component; and
e) controlling the target system by the further trained neural network.

2. The method as claimed in claim 1, wherein the first neural model component is represented by a number of first adaptive weights, and the second neural model component is represented by a number of second adaptive weights.

3. The method as claimed in claim 2, wherein the number of the first adaptive weights is several times greater than the number of the second adaptive weights.

4. The method as claimed in claim 2, wherein the first adaptive weights comprise a first weight matrix and the second adaptive weights comprise a second weight matrix.

5. The method as claimed in claim 4, further comprising determining adaptive weights of the neural model by multiplying the first weight matrix by the second weight matrix.

6. The method as claimed in claim 4, wherein the second weight matrix is a diagonal matrix.

7. The method as claimed in claim 1, wherein the first neural model component is not further trained.

8. The method as claimed in claim 2, wherein the further training of the trained neural model comprises a first subset of the first adaptive weights kept substantially constant while a second subset of the first adaptive weights is further trained.

9. The method as claimed in claim 1, wherein the neural model is a reinforcement learning model.

10. The method as claimed in claim 1, wherein the neural network operates as a recurrent neural network.

11. The method as claimed in claim 1, wherein the training of the neural model comprises determining whether the neural model reflects a distinction between the properties shared by the plurality of source systems and the properties varying between the plurality of source systems, and affecting the training of the neural model in dependence of the determining.

12. The method as claimed in claim 1, wherein policies resulting from the trained neural model are run in a closed learning loop with a technical target system.

13. An apparatus comprising:
at least one controller; and
at least one memory including computer program code for one or more programs, the at least one memory and the computer program code configured to, with the at least one controller, cause the apparatus to:
a) receive operational data of the plurality of source systems, the operational data being distinguished by source system specific identifiers;
b) train, by a neural network, a neural model on the basis of the received operational data of the plurality of source systems and the source system specific identifiers, wherein a first neural model component is trained on properties shared by the plurality of source systems and a second neural model component is trained on properties varying between the plurality of source systems;
c) receive operational data of the target system;
d) further train the trained neural model on the basis of the operational data of the target system to provide a further trained neural network, wherein a further training of the second neural model component is provided preference over a further training of the first neural model component; and
e) control the target system by the further trained neural network.

14. The apparatus as claimed in claim 13, wherein the first neural model component is represented by a number of first adaptive weights, and the second neural model component is represented by a number of second adaptive weights.

15. The apparatus as claimed in claim 14, wherein the first adaptive weights comprise a first weight matrix and the second adaptive weights comprise a second weight matrix.

16. The apparatus as claimed in claim 15, wherein the at least one memory and the computer program code are configured to cause the apparatus to further perform:
determine adaptive weights of the neural model by multiplying the first weight matrix by the second weight matrix.

17. The apparatus as claimed in claim 14, wherein the further training of the trained neural model comprises a first subset of the first adaptive weights kept substantially constant while a second subset of the first adaptive weights is further trained.

18. The apparatus as claimed in claim 13, wherein the training of the neural model comprises determining whether the neural model reflects a distinction between the properties shared by the plurality of source systems and the properties varying between the plurality of source systems, and affecting the training of the neural model in dependence of the determining.

19. The apparatus as claimed in claim 13, wherein policies resulting from the trained neural model are run in a closed learning loop with a technical target system.

20. A non-transitory computer-readable storage medium having stored therein a computer program for controlling a target system when executed by a computer, the storage medium comprising instructions for:
a) receiving operational data of the plurality of source systems, the operational data being distinguished by source system specific identifiers;
b) training, by a neural network, a neural model on the basis of the received operational data of the plurality of source systems and the source system specific identifiers, wherein a first neural model component is trained on properties shared by the plurality of source systems and a second neural model component is trained on properties varying between the plurality of source systems;
c) receiving operational data of the target system;
d) further training the trained neural model on the basis of the operational data of the target system to provide a further trained neural network, wherein a further training of the second neural model component is provided preference over a further training of the first neural model component; and
e) controlling the target system by the further trained neural network.
